(19) United States
(12) Patent Application Publication
(10) Pub. No.: US 2019/0312879 A1
(43) Pub. Date: Oct. 10, 2019

(54) SYSTEMS AND METHODS FOR CREATING A VERIFIED CUSTOMER PROFILE

(71) Applicant: Jerry Services, Inc., Palo Alto, CA (US)

(72) Inventors: Art Agrawal, Palo Alto, CA (US); Lina Zhang, Palo Alto, CA (US); Musawir Shah, Palo Alto, CA (US)

(73) Assignee: Jerry Services, Inc., Palo Alto, CA (US)

(21) Appl. No.: 16/379,409

(22) Filed: Apr. 9, 2019

Related U.S. Application Data
(60) Provisional application No. 62/655,100, filed on Apr. 9, 2018.
(60) Provisional application No. 62/672,072, filed on May 16, 2018.

(51) Int. Cl. H04L 29/06; G06F 16/9535; G06F 16/9536; G06Q 40/02

(52) U.S. Cl. CPC H04L 63/102; G06F 16/9535; G06Q 40/025; H04L 63/18; H04L 63/12; G06F 16/9536

(57) ABSTRACT

Systems and methods for creating a verified customer profile are disclosed. In some exemplary embodiments, a customer first provides a phone number. A message is then sent to the device associated with the phone number to request a specific response. When the specific response is received from the user, it is then verified that the user has possession of the device associated with the phone number. An identity query may be sent to each of multiple identity services and a response may be received from each of the multiple identity services in response to the identity query. The responses from each of the multiple identity services are then processed to determine the accuracy of the at least one of date of birth, address, or social security number of the customer in each response. The verified responses are stored as the basic profile of the customer in a database as records.

### RELATED APPLICATIONS

The present application claims priority to U.S. Provisional Application 62/655,100 titled Systems and Methods for Creating a Profile of a Customer for a Financial Service Rating Process and filed on Apr. 9, 2018, and to U.S. Provisional Application 62/672,072 titled Systems and Methods for Creating a Data Profile of a Customer and filed on May 16, 2018. The content of both applications are herein incorporated by reference in their entireties.

### FIELD OF THE DISCLOSURE

The present disclosure relates to systems and methods for securely creating a verified data profile of a customer.

### BACKGROUND

Financial products, such as bank accounts, insurance policies, loans, and the like, require that the service provider gauge the risk of the potential customer. In some cases, the history of the customer and other variables affects the terms, such as the premium on auto insurance or interest rate on a loan. For example, automobile insurance prices are all based on statistics and thus variables such as the driver's age, driving accident history, years of driving experience, what neighborhood the car is usually parked in overnight, the make and model of the car, safety and security features of the car(s) will affect the premium and the available coverage. The process by which an applicant gets quotes, or ‘rates’, for a particular financial product, such as auto insurance, home insurance, or a home mortgage, is known as “rating.”

Generally, rating is a complex computation system that requires various personal details of the applicant, i.e. a profile, as input. These inputs may include date of birth, address, credit history, education level, and many more pieces of data. Currently, if an individual is interested in getting rates or applying for a financial product, they have to assemble and provide all the required data to the financial institution. For particularly complex products, such as insurance, this task becomes increasingly difficult and time consuming, as well as prone to inaccuracies. For example, State Farm™ Insurance lists the following items as being needed for purchasing automobile insurance:
Year, Make, Model, Body style or VIN (Vehicle Information Number)
Mileage
Ownership
Garaged address
Name of registered owner
Prior insurance carrier and expiration date
Date of purchase
Driver name(s) and date of birth
Driver's license number(s) and state of issue
Ticket and accident history
License suspension information.
   https://www.statefarm.com/insurance/auto/resources/auto-insurance-checklist.

These documents are used by the customer to answer a multitude of questions. Generally, insurance companies ask customers anywhere from 20 to up to 50 questions before presenting customers with quotes (such as car insurance quote).

The rating process for a home mortgage can require even more documentation. Many banks require documentation of all bank accounts, real estate and any other assets, credit history, employment history and the like. Providing this documentation can be very burdensome for the customer. Since most of this documentation is in hard copy, it must be scanned or copied, making the process even more burdensome.

There have been many attempts to reduce the burden of the rating process on the customer. For example, Quicken Loans™ introduced Rocket Mortgage™, which provides a web based interface that simplifies the customer input needed for the rating process for a home mortgage. However, even Rocket Mortgage™ requires that the customer applying for a loan answer a series of questions in each of the following categories:
Living Situation
Home Information
Desired Location
Who's on the Loan
My Money
Government Questions
My Credit.
   While Rocket Mortgage™ may simplify the customer input required for the rating process as compared to traditional mortgage rating techniques, it is still relatively cumbersome and requires creating an account, logging in, and answering a series of questions. Further, many people are reluctant to provide the personal information necessary for conventional rating processes, especially over mobile deices which may be coupled a public network.

### SUMMARY

One aspect of the present disclosure relates to a system configured for creating a verified profile of a customer. The system may include one or more hardware processors configured by machine-readable instructions. The processor(s) may be configured to receive a phone number from the customer. The processor(s) may be configured to send a message to the device associated with the phone number requesting a specific response. The processor(s) may be configured to receive the specific response from the user to verify that the user has possession of the device associated with the phone number. The processor(s) may be configured to request the customer's name. The processor(s) may be configured to receive the customer's name. The processor(s) may be configured to send an identity query to each of multiple identity services. The identity query may include the customer's name and phone number. The processor(s) may be configured to, in response to the identity query, receive a response from each of the multiple identity services. Each response may include at least one of date of birth, address, or social security number (“SSN”) of the customer. The processor(s) may be configured to process the responses from each of the multiple identity services to determine the accuracy of the at least one of date of birth, address, or social security number of the customer in each response. The processor(s) may be configured to generate a verified basic profile base on the determined accuracy that may include the customer's name, phone number, date of birth, address and social security number. The processor(s) may be configured to store the basic profile as a record in a database.

Another aspect of the present disclosure relates to a method for creating a profile of a customer for a financial service rating process. The method may include receiving a phone number from the customer. The method may include sending a message to the device associated with the phone number requesting a specific response. The method may include receiving the specific response from the customer to verify that the customer has possession of the device associated with the phone number. However, a customer name is not required. In some embodiments, the request does not ask for the customer's name. In other embodiments, the method may include requesting the customer's name. The method may further include receiving the customer's name. The method may include sending an identity query to each of multiple identity services. The identity query may include the customer's name and phone number. The method may include, in response to the identity query, receiving a response from each of the multiple identity services. Each response may include at least one of date of birth, address, or social security number of the customer. The method may include processing the responses from each of the multiple identity services to determine the accuracy of the at least one of date of birth, address, or social security number of the customer in each response and generate a verified profile base on the determined accuracy that may include the customer's name, phone number, date of birth, address and social security number. The method may include storing the basic profile as a record in a database.

Yet another aspect of the present disclosure relates to a non-transient computer-readable storage medium having instructions embodied thereon, the instructions being executable by one or more processors to perform a method for creating a profile of a customer for a financial service rating process. The method may include receiving a phone number from the customer. The method may include sending a message to the device associated with the phone number requesting a specific response. The method may include receiving the specific response from the user to verify that the user has possession of the device associated with the phone number. In some embodiments, the request does not ask for the customer's name. In other embodiments, the method may include requesting the customer's name. The method may include receiving the customer's name. The method may include sending an identity query to each of multiple identity services. The identity query may include the customer's name and phone number. The method may include, in response to the identity query, receiving a response from each of the multiple identity services. Each response may include at least one of date of birth, address, or social security number of the customer. The method may include processing the responses from each of the multiple identity services to determine the accuracy of the at least one of date of birth, address, or social security number of the customer in each response. The processor(s) may be configured to generate a verified basic profile base on the determined accuracy that may include the customer's name, phone number, date of birth, address and social security number. The method may include storing the basic profile as a record in a database.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for creating a verified profile of a customer in accordance with one or more implementations.

FIG. 2 illustrates a method for creating a basic profile of a customer, in accordance with one or more implementations

FIG. 3 illustrates a method for supplementing the basic profile of a customer, in accordance with one or more implementations.

FIG. 4 illustrates an exemplary data flow between the server and client device(s) for obtaining basic identity information in an implementation.

FIG. 5 illustrates an exemplary data flow for supplementing a basic profile and aggregating ratings.

### DETAILED DESCRIPTION

The Pew Research Center Internet & American Life Project found that mobile phone ownership among adults exceeds 95%, thereby making mobile phones the most widely owned device in the US, if not around the world. See http://www.pewinternet.org/fact-sheet/mobile/. As individuals continue to transition their personal financial transactions from offline to online, their phones play an increasingly important part as their primary management device. Due to this critical and intimate role of their phones, the identity profile based on an individual's phone number is very unique and accurate. The embodiments create a new identity profile based on a phone number. The identity profile can be used to seamlessly and securely collect and transmit all required customer/applicant data to a trusted financial institution for rating without further interaction from the user.

Starting with a phone number, the complete data set of the profile can be constructed to allow a financial services provider, such as an insurance carrier to effectively rate an individual. Therefore, insurance rates (by insurance carriers) can be resolved from only the phone number associated with the individual's mobile device or other data identifying a physical device associated with the individual. This reduces manual data entry by the user, and eliminates the need for the customer to enter sensitive data (such as a SSN) which can result is data breach and identity theft. The embodiments can be applicable to a variety of products, e.g., products' offerings that require consumer's credit score, or other behavior or characteristics. This includes: insurance (auto, home, renters, life, certain commercial insurance, etc), loan (e.g., home, auto, student, small loan, certain commercial loan, equity line, etc), credit card, and rental activities (e.g., renting a home, short term or long term, car, or other articles of significant value).

Conventional shopping for financial service or product (for example an insurance product) may require customers to answer 20-50 questions and take at least 10 to 30 minutes. The present disclosure allows getting a price or price estimate in under a minute (e.g., less than 5 seconds, 10 seconds, 15 seconds, 30 seconds, 45 seconds, etc.) or almost instantly from the time of customer entering the first piece of information. Because the customer need not input as much personal information over a network connection that might not be secure (such as public Wi-Fi) the rating process can be made for secure by limiting personal data to more secure channels without disrupting the convenience and general mobile nature of user devices.

Further, the embodiments allow identification of a new segment of users, labeled as “passive loyalists,” who are loyal to a brand or product and stay with a brand or product due to either laziness or confusion caused by the dizzying array of choices. These “passive loyalists” would otherwise not be shopping, but now are open to shopping. They care about convenience, avoid shopping not because they have loyalty to the products they are currently using, but because shopping is inconvenient for them. Passive loyalists also will feel more comfortable not having to enter provide information such as social security numbers. The present application discloses advanced methods, apparatus and systems that can be configured to automatically obtain various customer information that are relevant in assessing financial risks, for example, credit score, SSN, education, income, profession, etc. By doing so, customers no longer need to answer 20 to 50 questions before being provided an insurance quote. In some embodiments, a customer's information relevant to financial risk assessment may be obtained based on the customer's cell phone number.

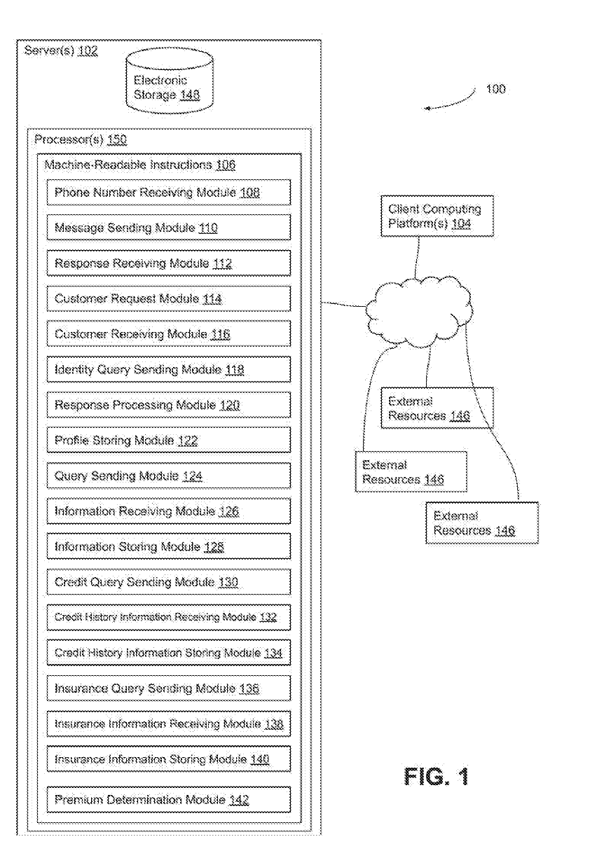

In some embodiments, “price” or “rate” may be used interchangeably. In the context of insurance product or service, “price” may be named as “premium.” In the context of loan, “price” or “rate” may refer to interest rate and/or loan amount. A price estimate may be referred to as “quote.” In some embodiments, carrier and insurance carrier mean insurance company. FIG. 1 illustrates a distributed computer architecture of a system 100 configured for creating a profile of a customer, in accordance with one or more implementations. In some implementations, system 100 may include one or more servers 102. Server(s) 102 may be configured to communicate with one or more remote client computing platforms 104 according to a client/server architecture and/or other architectures. The client computing platforms can be a mobile phone coupled to the servers 102 through a mobile network. Client computing platform(s) 104 may be configured to communicate with other client computing platforms via server(s) 102 and/or according to a peer-to-peer architecture and/or other architectures. Users may access server(s) 102 via client computing platform(s) 104. System 100 also includes external resources 146 (three of which are shown). External resources 146, which can be remote, can be any type of database and/or service provider that provides the processing and data described below. There can be any number of external resources 146.

Server(s) 102 may be configured by machine-readable instructions 106. Machine-readable instructions 106 may include one or more instruction modules. The instruction modules may include computer program modules. The instruction modules may include one or more of a phone number receiving module 108, a message sending module 110, a response receiving module 112, a customer request module 114, a customer receiving module 116, an identity query sending module 118, a response processing module 120, a profile storing module 122, a query sending module 124, an information receiving module 126, an information storing module 128, a credit query sending module 130, a credit history information receiving module 132, a credit history information storing module 134, an insurance query sending module 136, an insurance information receiving module 138, an insurance information storing module 140, a customer name receiving module 142, a premium determination module 144, and/or other instruction modules. Phone number receiving module 108 may be configured to receive a phone number from the customer, i.e. the party desiring to be rated for a product. Message sending module 110 may be configured to send a message to the device associated with the phone number requesting a specific response. The message may be an SMS (or short message service) message, or other type of text message, and the specific response can include a code in the message. Response receiving module 112 may be configured to receive the specific response from the user to verify that the user has possession of the device associated with the phone number. This provides verification of the individual's identity without requiring the individual to provide sensitive identification information, such as a social security number, over a mobile network channel.

Customer request module 114 may be configured to request the customer's name from the customer or from one of external resources 146. Customer receiving module 116 may be configured to receive the customer's name. Identity query sending module 118 may be configured to send an identity query to each of multiple identity services (which are shown as external resources 146) and, in response to the identity query, receive a response from each of the multiple identity services. By way of non-limiting example, each response may include at least one of date of birth, address, or social security number of the customer. The social security number may be a number. The social security number may include the number of a particular individual's Social Security account, according to some implementations.

Response processing module 120 may be configured to process the responses from each of the multiple identity services to determine the accuracy of the at least one of date of birth, address, or social security number of the customer in each response. Response processing module 120 also generates a verified basic profile base on the determined accuracy that may include the customer's name, phone number, date of birth, address and social security number. To determine the accuracy of the responses received from the multiple identity services, the response processing module 120 may compare the received responses with each other. In some embodiments, determining accuracy of data output from data providers are necessary when there are multiple outputs (either from same data provider, or from multiple data providers). Accuracy can be determined by multiple factors, such as when the data record was created (how recent the data record is); and/or whether a particular data output has more detailed information (such as whether it has higher number of attributes). In determining data accuracy, variable weight can be assigned based on these factors, in a linear or non-linear fashion. Methods such as assigning penalty function, or prior error distribution may be used.

Profile storing module 122 may be configured to store the basic profile as a record in a database. The database may include an organized body of related information, according to some implementations. Examples of the database may include a relational database, a distributed ledger, or a list. The database may be stored locally, remotely, or in a distributed manner.

Query sending module 124 may be configured to send a social query to each of multiple online social profile providers (as external resources 146) of the customer. Social profile providers can be any type of social network, such as Linkedin™ or Facebook™, or any other collection of social relationship data. The social query may include information in the basic profile. Information receiving module 126 may be configured to, in response to the social query, receive additional information from external resources 146 related to the customer. By way of non-limiting example, the additional information may include at least one of email address, education level, or profession. The profession may be an occupational group or any other relevant group. Information storing module 128 may be configured to store the additional information in the database in correspondence to the basic profile.

Credit query sending module 130 may be configured to send a credit query to a credit scoring database (as an external resource 146). The credit query may include at least the social security number of the customer. Credit scoring databases include Experian, TransUnion, and Equifax™ . . . . Credit history information receiving module 132 may be configured to, in response to the credit query, receive credit history information of the customer from the credit scoring databases. Credit history information storing module 134 may be configured to store the credit history information in the database in correspondence to the basic profile.

Insurance query sending module 136 may be configured to send an insurance query to each of multiple insurance provider databases as external resources 146. The insurance provider databases can be insurance providers such as Allstate™ and Geico™. The insurance query may be directly querying insurance carrier or provider, or indirectly querying insurance carrier or provider through a rating intermediary (such as Ezlynx, or PL rater, etc.). The insurance query may include information from the basic profile,the additional information or the credit information. Insurance information receiving module 138 may be configured to, in response to the insurance query, receive from the insurance provider databases, insurance policy information relating to the customer's insured asset. By way of non-limiting example, the insurance policy information relating to the customer's insured asset may include at least one of an identification of the asset, the parties insured, and policy coverage details. By way of non-limiting example, the insurance information relating to the customer's insured asset may include at least one year, make, model, trim, and vin of an automobile, and driver's details corresponding the customer. Insurance information storing module 140 may be configured to store the insurance information in the database in correspondence to the basic profile. Premium determination module 142 may be configured to determine a premium for automobile insurance based on the basic profile. By way of non-limiting example, the additional information, the credit history information, and the insurance information. Note that premium determination module 142, while shown as part of server 202, can be part of an external device 146, namely a computing platform of an insurance provider.

In some implementations, requesting the customer's name may include sending a name query to a caller ID service. A caller ID service may be a service or database that is based on the customer database(s) from one or more telecommunication companies (such as Verizon, T-Mobile, AT&T, etc.). In an alternative, the customer can be prompted to input their name. In some implementations, the processing may include disambiguation of data in the responses from each of the multiple identity services by comparing corresponding data in the responses from each of the multiple identity services and determining the reliability of the data based on the comparison.

Server(s) 102, client computing platform(s) 104, and/or external resources 146 may be operatively linked via one or more electronic communication links. For example, such electronic communication links may be established, at least in part, via a network such as the Internet and/or other networks including mobile wireless networks. It will be appreciated that this is not intended to be limiting, and that the scope of this disclosure includes implementations in which server(s) 102, client computing platform(s) 104, and/or external resources 146 may be operatively linked via some other communication media. The information may be exchanged over secure connections, such as by using HTTPs or another secure communication protocol.

A given client computing platform 104 may include one or more processors configured to execute computer program modules. The computer program modules may be configured to enable an expert or user associated with the given client computing platform 104 to interface with system 100 and/or external resources 146, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a mobile phone such as a Smartphone, a gaming console, and/or other computing platforms. External resources 146 may include sources of information outside of system 100, external entities participating with system 100, and/or other resources.

Server(s) 102 may include electronic storage 148, one or more processors 150, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 148 may comprise non-transitory storage media that electronically stores information. The electronic storage media of electronic storage 148 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 148 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 148 may include one or more virtual storage resources (e.g., cloud storage, a virtual private network, and/or other virtual storage resources). Electronic storage 148 may store software algorithms, information determined by processor(s) 150, information received from server(s) 102, information received from client computing platform(s) 104, and/or other information that enables server(s) 102 to function as described herein.

Processor(s) 150 may be configured to provide information processing capabilities in server(s) 102. As such, processor(s) 150 may include one or more of a digital processor, an analog processor, a digital circuit designed to process information, an analog circuit designed to process information, a state machine, and/or other mechanisms for electronically processing information. Although processor(s) 150 is shown in FIG. 1 as a single entity, this is for illustrative purposes only. In some implementations, processor(s) 150 may include a plurality of processing units. These processing units may be physically located within the same device, or processor(s) 150 may represent processing functionality of a plurality of devices operating in coordination. Processor(s) 150 may be configured to execute modules 108, 110, 112, 114, 116, 118, 120, 122, 124, 126, 128, 130, 132, 134, 136, 138, 140, 142 and/or other modules by software; hardware; firmware; some combination of software, hardware, and/or firmware; and/or other mechanisms for configuring processing capabilities on processor(s) 150. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, 140, and 142 are illustrated in FIG. 1 as being implemented within a single processing unit, in implementations in which processor(s) 150 includes multiple processing units, one or more of the modules may be implemented remotely from the other modules. The description of the functionality provided by the different modules described above is for illustrative purposes, and is not intended to be limiting, as any of modules may provide more or less functionality than is described. For example, one or more of the modules may be eliminated, and some or all of its functionality may be provided by other modules.

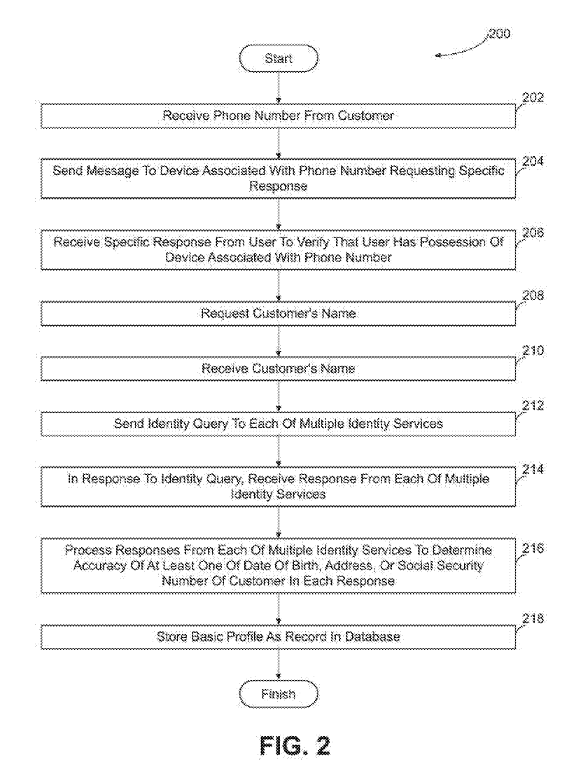

FIG. 2 illustrates a method 200 for creating a basic profile of a customer, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving a phone number from the customer. Operation 202 may be performed by one or more hardware processors configured by machine-readable instructions including a module that is the same as or similar to phone number receiving module 108, in accordance with one or more implementations. Operation 202, and other communication between the customer and the system, can be accomplished over a non-secure communication channel, such as a public Wi-Fi network because there is no need for the customer to provide sensitive information such as their address or social security number.

An operation 204 may include sending a message to the device associated with the phone number requesting a specific response. Operation 204 may be performed by one or more hardware processors configured by machine-readable instructions including a module that is the same as or similar to message sending module 110, in accordance with one or more implementations.

An operation 206 may include receiving the specific response from the user to verify that the user has possession of the device associated with the phone number. Operation 206 may be performed by one or more hardware processors configured by machine-readable instructions including a module that is the same as or similar to response receiving module 112, in accordance with one or more implementations.

An operation 208 may include requesting the customer's name. Operation 208 may be performed by one or more hardware processors configured by machine-readable instructions including a module that is the same as or similar to customer request module 114, in accordance with one or more implementations.

An operation 210 may include receiving the customer's name. Operation 210 may be performed by one or more hardware processors configured by machine-readable instructions including a module that is the same as or similar to customer receiving module 116, in accordance with one or more implementations.

An operation 212 may include sending an identity query to each of multiple identity services. The identity query may include the customer's name and/or phone number. Operation 212 may be performed by one or more hardware processors configured by machine-readable instructions including a module that is the same as or similar to identity query sending module 118, in accordance with one or more implementations.

In some embodiments, an additional operation is included, wherein the operation includes requesting the customer's address. An operation may include receiving the customer's address. It may be performed by one or more hardware processors configured by machine-readable instructions including a module that is the same as or similar to customer receiving module 116, in accordance with one or more implementations. An operation may include sending an identity query to one or more multiple identity services, based on the customer's address. The identity query may include the customer's address, name, and/or phone number. Operation(s) may be performed by one or more hardware processors configured by machine-readable instructions including a module that is the same as or similar to customer receiving module 116, in accordance with one or more implementations. Transmission of the customer's address can be accomplished over the same communication channel as transmission of the customer phone number. However, it could be accomplished over a more secure channel by, for example, sending an email to a customer computing platform that is not on a public network and having the customer respond over the more secure network.

An operation 214 may include, in response to the identity query, receiving a response from each of the multiple identity services. Each response may include at least one of date of birth, address, or social security number of the customer. Operation 214 may be performed by one or more hardware processors configured by machine-readable instructions including a module that is the same as or similar to response receiving module 112, in accordance with one or more implementations. This operation and the following operations can be accomplished over secure communication channels.

An operation 216 may include processing the responses from each of the multiple identity services to determine the accuracy of the at least one of date of birth, address, or social security number of the customer in each response. Generate a verified basic profile base on the determined accuracy that may include the customer's name, phone number, date of birth, address and social security number. Operation 216 may be performed by one or more hardware processors configured by machine-readable instructions including a module that is the same as or similar to response processing module 120, in accordance with one or more implementations.

An operation 218 may include storing the basic profile as a record in a database. Operation 218 may be performed by one or more hardware processors configured by machine-readable instructions including a module that is the same as or similar to profile storing module 122, in accordance with one or more implementations.

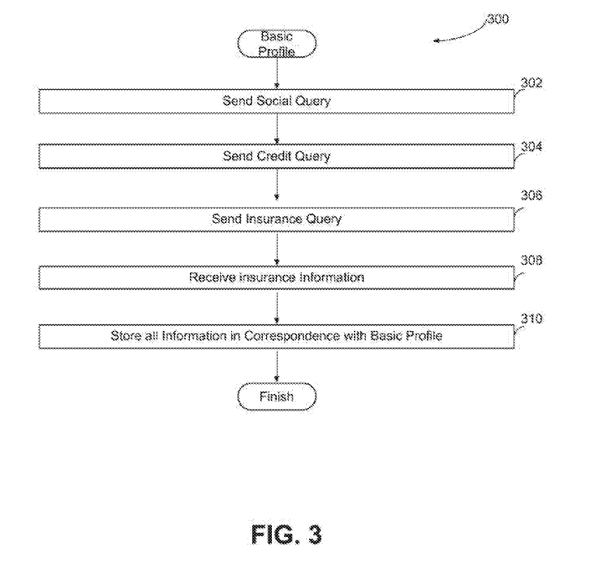

FIG. 3 illustrates a method of further supplementing the basic profile created by the process of FIG. 2. A query operation 203 may send a social query to each of multiple online social profile providers (as external resources 146) of the customer. Social profile providers can be any type of social network, such as Linkedin™ or Facebook™, or any other collection of social relationship data. The social query may include information in the basic profile. Information receiving module 126 may be configured to, in response to the social query, receive additional information from external resources 146 related to the customer. By way of non-limiting example, the additional information may include at least one of email address, education level, or profession. The profession may be an occupational group or any other relevant group. Information storing module 128 may be configured to store the additional information in the database in correspondence to the basic profile.

A credit query operation 304 may send a credit query to a credit scoring database (as an external resource 146). The credit query may include at least the social security number of the customer and, in response to the credit query, receive credit history information of the customer from the credit scoring databases.

An insurance query operation 306 may send an insurance query to each of multiple insurance provider databases as external resources 146. The insurance query may include information from the basic profile. An insurance information receiving operation 308 may be configured to, in response to the insurance query, receive from the insurance provider databases, insurance policy information relating to the customer's insured asset. A storing operation 310 can cause all information gathered in steps 302-306 to be stored in correspondence with the basic profile. The storing operation can be multiple individual operations for storing each type of data and can occur at any time during the process as needed.

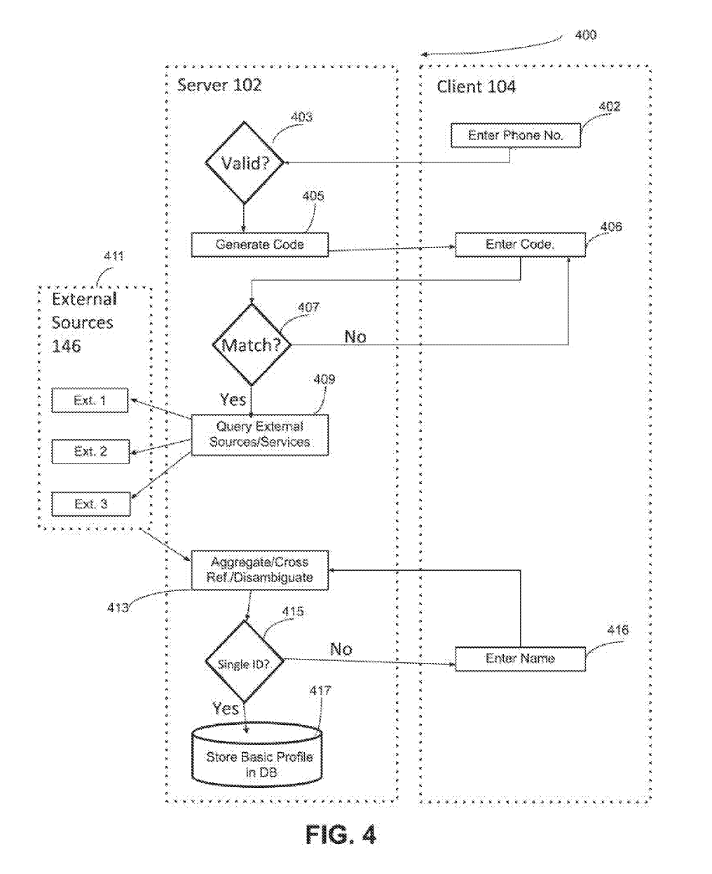

FIG. 4 illustrates the data flow for generating the basic profile between server 102 and client computing platform 104, which can include a user mobile phone, in accordance with one example. At step 402, a user enters their phone number. This step can be accomplished in response to a UI presented on the user phone by server 102, when a user is logged into a web site or is executing an app for example. Alternatively, the phone number can be entered by sending a message, such as an SMS message or an email message to a specified address associated with server 102. At 403, server 102 determines if the phone number is valid. This determination can be merely a determination that the phone number has the proper format and number of digits or can be more complex, such as querying a source to determine if the number is active, in a desired area code, or the like. If the phone number is determined as valid, server 102 generates a unique, or somewhat unique, code at 405 and sends the code to the phone number of client device 104. At 406, the user enters the code into the UI, or via messaging or the like.

At 407, server 102 determines if the code from client 104 matches the code sent to client 104. If there is a match, server 102 knows that the user is in possession of the phone corresponding to the phone number. If there is not a match, the user is given another opportunity to enter the code as the process returns to 406. Such a loop can occur for a predetermined amount of time or attempts to see if the user enters the matching code. If there is a match, the process proceeds to 409 at which external sources/services 146 are queried for information relating to the user as described above with reference to FIGS. 2 and 3.

The results of the queries are returned to server 102 and processed at 413. The processing can include aggregating, cross referencing, and disambiguating as described above. At 415, it is determined if the processing has yielded a single identity (ID) with at least a predetermined threshold certainty. If the processing has not yielded a dingle identity, the user is prompted to enter their name at 416 and the name is used in step 413 to further process the query results to yield a single identity (“ID”). If there is a single ID, the processed query results are stored in the database as the basic profile.

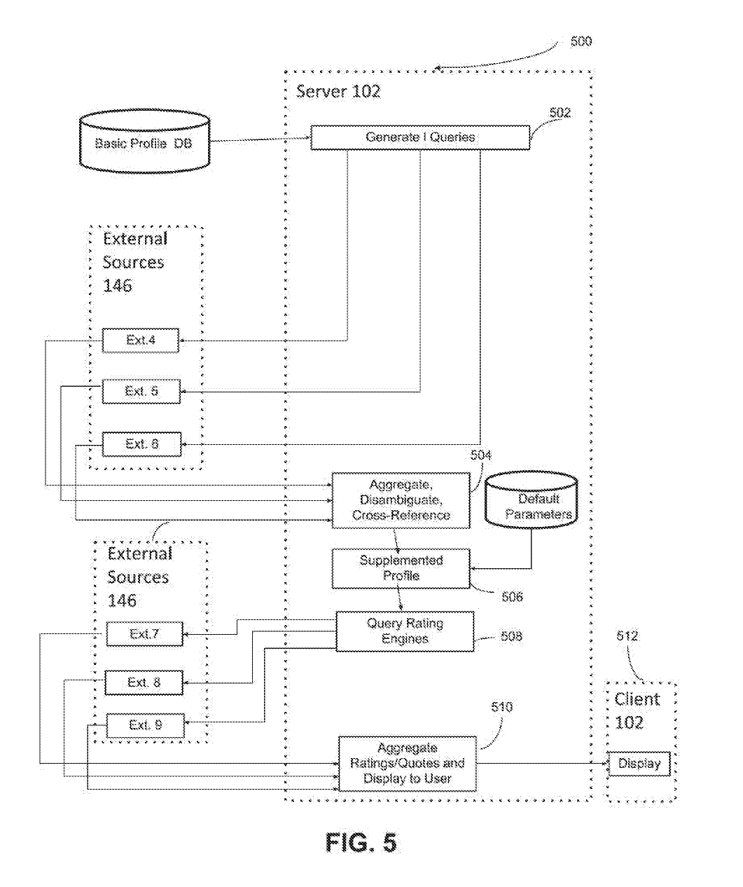

FIG. 5 illustrates the data flow for supplementing the basic profile and aggregating ratings for a user. At 502, basic profile information for a user is received by server 102 and server 102 generates queries based on the received information. The queries are sent to external sources 146, such as social networks, credit services, and insurance information providers described with respect to FIG. 3. At 504, responses to the queries are aggregated, disambiguated and cross referenced. At 506, the processed information is stored as supplemental information in association with the basic profile information of the user. At 508, rating engines (external sources 146), such as automobile insurance rating services, are queried using the basic and supplemented profile information. at 510, the responses to the queries, e.g. rating and pricing information for insurance products for the user, are aggregated and sent to the user device for display at 512. Note that, at 506, default parameters may be added to the supplemented profile as needed. For example, there are parameters that some rating engines require that cannot always be ascertained. In such a case, default parameters which are not likely to affect the rating are added. For example, some possible default parameters and values therefore are displayed below.
Age Licensed: 16
Driver License Status: Valid
Marital Status: Domestic Partner
License Revoked or Suspended: No
Years With Continuous Coverage: 3 years
Years With Prior Carrier: 3 years
Prior Policy Term: 12 month
Prior Liability Coverage Limit per person/per accident: $100,000/$300,000

Examples of disambiguation techniques, algorithms and services are provided below. A query to a data provider at any step may return multiple results. Furthermore, some data attributes returned can be partial. To resolve such conflicts, the disclosure comprises querying multiple data providers with the same query and find the subset of properties that is aligned with the majority of the results. A clustering technique can be applied to achieve this, using an appropriate distance measure for the underlying attribute, such as K-means Clustering, Mean-Shift clustering, Density-Based Spatial Clustering of Applications with Noise (DBSCAN), Expectation-Maximization (EM) Clustering using Gaussian Mixture Models (GMM), Agglomerative Hierarchical Clustering. For example, one could employ K-Means clustering on an attribute, such as the “name,” thereby creating clusters: c1={name1, name2}, c2={name3}. The largest cluster denotes the highest match. The value from the best matching cluster is then selected using some quality metric appropriate to the underlying attribute, such as the length in the case of name.

A query to a data provider or service may return multiple customer datasets, based on the query input. Each of the multiple output datasets may include customer name, address, time period at the address, SSN, and/or date of birth. In some embodiments, with multiple output, score may be assigned to favor certain output. For example, a higher score may be assigned to a certain output address if customer has been at the address for a longer period of time or the address is a more recent address for the customer. Clustering method such as K-Means may be used to identify which data output(s) are more accurate.

In any of the embodiments or disclosures described herein, a data or identity provider or service or database may include any of the following data providers or services or databases associated with any of the following data providers or services: Acxiom Corporation, DataLogix Holdings, Inc., Epsilon Data Management, LLC, Equifax, Inc., Experian, Fair Isaac Corporation, Harte-Hanks, Inc., Intelius, Inc.,LexisNexis, TransUnion, Ameridex, BeenVerified, Email Finder, InfoPay EmailTracer, Innovis, Inc., LocatePeople.org, LocatePLUS, MelissaData.com, Meredith Corporation, Merlin Information Services, Merkle, Inc., PeopleFinders.com, Peoplelookup.com, PeopleSearchNow.com, People Search Pro, Phone Detective, PrivateEye, PublicBackgroundChecks.com, PublicRecordsNOW, USA People Search, US Search.com, Veromi.net, Westlaw, Thompson Reuters Corp., ZABA Inc., Abacus Cooperative, Aristotle/Voter Lists Online, ChoicePoint Precision Marketing, Cox Target Media (Valpak), DirectMail.com, Direct Marketing Association (DMA), Dun & Bradstreet Corp., Dex Media (Phonebooks), Tower Data, Haines Criss+Cross, Infogroup Inc., Money Mailer, Publishers Clearing House, Reader's Digest, Suarez Corporation Industries, Valassis Communications, Inc., State DMVs (any of the 50 states in US), CarFax, Zillow, Verisk, phone company database, telecommunication company database, any of the affiliates or subsidiaries of the above-mentioned companies, or any data providers or services that obtain data from any of the said data providers or services above.

The implementations above can be applied to various methods and apparatus. For example, the method can include providing an insurance price or premium estimate to a customer by receiving no more than 10 pieces of information related to the customer and using the information to query at least 1 database to obtain additional information related to the customer that are required for obtaining the price or premium estimate. The (initial) information is provided by the customer but the additional information is not provided by the customer. The information provided by the customer along with the additional information is transmitted to an insurance rating server, which computes a price or premium estimate based on the transmitted information.

In some embodiments, a system is disclosed for creating a profile of a customer or configured for providing an insurance price or premium estimate to a customer. The system can include one or more hardware processors configured by machine-readable instructions to receive no more than 10 pieces of information related to the customer that is provided by the customer. The processors are further configured to use the information provided by the customer to query at least one database to obtain additional information related to the customer that are required for obtaining the price or premium estimate. This additional information is not provided by the customer. The information provided by the customer and the additional information are transmitted to an insurance rating server for computing the price or premium estimate. In one embodiment, the insurance rating server computes the price or premium estimate based on the transmitted information. The system described herein can include one or more hardware processors configured by machine-readable instructions to store the basic profile including information provided by the customer and the additional information as a record in a database.

In some embodiments, methods of creating a profile of a customer for a financial service rating process are disclosed. Such methods do not require a customer to provide no more than 10 pieces of information. The information provided by the customer is used to obtain additional information by querying one or more databases. The additional information may be required for obtaining a financial rating for the customer. In the methods disclosed herein, the customer is not required to provide the additional information.

Also provided herein is a non-transient computer-readable storage medium having instructions embodied thereon, the instructions being executable by one or more processors to perform the methods disclosed herein for creating a profile of a customer for a financial service rating process.

In any of the disclosed methods, processes, apparatus and systems provided herein, the number of pieces of information to be provided by a customer may be varied. The customer may be required to provide 10, 9, 8, 7, 6, 5, 4, 3, 2, or 1 piece of information to obtain a financial rating. In any of the methods provided herein, the information to be provided by the customer can include a customer's name, phone number, date of birth, social security number, address, and/or driver's license information (driver's license number and issuing state). Herein, the customer's name may refer to customer's first name and/or customer's last name. In some embodiments, a customer's name is the customer's full name including first name and last name.

In some embodiments, the customer is required to provide no more than 3 pieces of information relating to the customer, for example, any of the 3 pieces of information regarding customer's name, phone number, date of birth, social security number, address, and/or driver's license information (driver's license number and issuing state). In some embodiments, the customer is required to provide no more than 2 or 3 pieces of information including the customer's name and address. In some embodiments, the customer is not required to provide no more than 2 or 3 pieces of information including the customer's name and phone number. In some embodiments, the customer is required to provide no more than 1 piece of information including customer's phone number. In some embodiments, the receiving step is a step of receiving customer's name and address or the customer's name and phone number or only the customer's phone number. In any of the embodiments provided herein, the phone number can be a mobile or cell phone number. In any of the embodiments provided herein, the customer's address can include the customer's state of residence, city, zip code, and/or street address. In any of the embodiments provided herein, the customer's address can be the customer's street address with state and city. In any of the embodiments provided herein, the customer's address can be the customer's zip code.

In some embodiments, multiple databases can be queried using a customer's name, date of birth, address, and/or phone number. The financial service rating can be an insurance product rating. The financial service can be an insurance product or service. The financial service rating or insurance price or premium estimate can be presented to the customer (or the customer's agent or representative or family member). The financial service or insurance rating server does not necessarily require additional information from the customer to compute a price or premium estate, a financial rate or estimate.

In some embodiments, the information provided by the customer can be evaluated for accuracy. In some embodiments, the information is entered into a device (computer or cell phone) by the customer. In one embodiment, the customer receives a communication to verify the information (e.g., verification code sent to the phone number that the customer entered). The various verification steps can be performed sequentially or concurrently.

In some embodiments, the price or rate or premium estimate can be the final price at which the customer purchases the financial service or insurance. The price or rate or premium estimate can be at least 80%, 85%, 90%, or 95% of the final price at which the customer purchases the financial service or insurance. The additional information can be one or more of the following: name, address, SSN, date of birth (DOB) of the customer. However, the customer is not required to provide their name, DOB, or address. The information can be provided by the customer directly or indirectly (for example, “directly” may mean that the customer enters the information at the time of requesting the rate or price or premium estimate; “indirectly” may mean that the customer enters the information through an agent, representative, intermediary, or a family member).

In some embodiments, the price or premium or rate estimate can be provided to the customer in less than 10 sec, 30 sec, or 1 min after receiving the customer information. The price or premium estimate for an insurance service or product can be a final, binding price, or it can be a “bindable” price upon receipt of further information from a motor vehicle record (MVR), Comprehensive Loss Underwriting Exchange (CLUE) report, and credit report. In any of the disclosures provided herein, the insurance policy, service, or product is auto insurance, renters insurance, homeowner insurance, or condo insurance. The insurance policy, service, or product can be liability coverage only. The insurance policy, service, or product can have a state required minimum coverage for liability.

In some embodiments, systems configured for creating a profile of a customer (or user) for a financial service or financial product rating process (or a financial service or financial product) are disclosed. Such system may include one or more hardware processors configured by machine-readable instructions to create a profile of a customer by first receiving a phone number from the customer and sending at least one identity query to one or more data or identity databases (or data or identity services). The identity query may include the customer's phone number. After the query, a response may be received from the one or more data or identity databases (or data or identity services). The response may include at least one of name, date of birth, address, and social security number of the customer. The response is processed to generate a profile of the customer for a financial service or financial product rating process (or a financial service or financial product).

Embodiments can include methods for creating a profile of a customer (or user) for a financial service or financial product rating process (or a financial service or financial product). Such method include the steps of receiving a phone number from the customer and sending at least one identity query to one or more data or identity databases (or data or identity services). The identity query may include the customer's phone number. After the query, a response may be received from the one or more data or identity databases (or data or identity services). The response may include at least one of name, date of birth, address, and social security number of the customer. The response is processed to generate a profile of the customer for a financial service or financial product rating process (or a financial service or financial product).

Embodiments can include computer-readable storage medium (e.g., non-transient computer-readable storage medium) having instructions embodied thereon, the instructions being executable by one or more processors to perform methods of creating a profile of a customer (or user) for a financial service or financial product rating process (or a financial service or financial product) as disclosed above.

In any of the systems, methods or readable storage media described herein, multiple identity queries and/or querying multiple identity databases (or data or identity services) can be accomplished. The responses from each of the queries can be processed to determine the accuracy or specificity of the customer information, including name, date of birth, address, or social security number. The processing can be by aggregation, cross referencing, and/or disambiguation. Multiple responses (such as name, or address) may be processed to assign a value relating to each response, the value may be based on the length of customer having that response (such as name, or address) or how recent in time the customer has that response (such as name, or address). Responses may be selected based on the value to form a customer profile. In some embodiments, there can be at least one of 50%, 55%, 65%, 70%, 75%, 80%, 85%, 90%, 95%, 96%, 97%, 98%, or 99%, or 100% identity match rate using one or more identity queries to one or more data or identity databases (or data or identity services).

In any of the systems, methods, or readable storage media described herein, the identity query optionally includes the name and/or address information. In some embodiments, the identity query includes customer name and phone number. In some embodiments, the identity query includes customer name, phone number, and address information.

In any of the systems, methods or readable storage media described herein, the present disclosure comprises storing profile or basic profile as a record in a database.

In some embodiments, systems configured for providing rate, price or price estimate for a financial service or product are disclosed. Such system may include one or more hardware processors configured by machine-readable instructions to receive no more than 10 pieces of information related to the customer, the information being provided by the customer. The one or more hardware processors are further configured by machine-readable instructions to use the information provided by the customer to query one or more data or identity databases (or data or identity services) to obtain additional information related to the customer. The additional information is not provided by the customer. The one or more hardware processors are further configured to transmit the customer information obtained from the customer and from the query to a financial service (or financial product) rating server (or pricing server) to compute a rate, price or price estimate. The financial service (or financial product) rating server (or pricing server) is configured to compute the rate, price or price estimate based on the transmitted information.

In some embodiments, similar methods for providing rate, price or price estimate for a financial service or product are disclosed.

In some embodiments, instructions stored on a computer-readable storage medium (e.g., non-transient computer-readable storage medium) to perform a method for providing price or price estimate for a financial service or product are disclosed. The method includes receiving no more than 10 pieces of information related to the customer. The information is provided by the customer. The method further includes using the information provided by the customer to query one or more data or identity databases (or data or identity services) to obtain additional information related to the customer, wherein the additional information is not provided by the customer. The customer information obtained from the customer and from the query is transmitted to a financial service (or financial product) rating server (or pricing server) to compute a price or price estimate. The financial service (or financial product) rating server (or pricing server) is configured to compute the price or price estimate based on the transmitted information.

In some embodiments, the information provided by the customer and the information obtained from the query are used to create a customer profile. The profile is transmitted to a financial service (or financial product) rating server (or pricing server) to compute a price or price estimate. The financial service (or financial product) rating server (or pricing server) is configured to compute the price or price estimate based on the transmitted information.

In any of the systems, methods, or readable storage media described herein, the additional information obtained by querying one or more databases is necessary or required for obtaining a price or price estimate for a financial product or service (e.g., insurance product or service). In any of the systems, methods, or readable storage media described herein, the information provided by the customer and the additional information obtained from querying one or more databases are sufficient for obtaining a price or price estimate for a financial product or service (e.g., insurance product or service). In some embodiments, the financial product service is an insurance product or service. In some embodiments, the insurance product or service is auto insurance. In some embodiments, the insurance product or service is home insurance. In some embodiments, the insurance product or service is provided by an insurance carrier or provider that requires customer to answer at least any of 10, 15, 20, 25, 30, 35, 40, 45, 50 questions or provide at least any of 10, 15, 20, 25, 30, 35, 40, 45, 50 pieces of information in order to provide a price or price estimate on the insurance product (e.g., the questions asked for getting a quote at: www.statefarm.com). An insurance company or carrier provided in the present disclosure may be any one or more of the following: AllState, Geico, StateFarm, AAA, AIG, ASI, American Collectors, AmWINS, American Modern, American Family Insurance, Amica, Burns & Wilcox, Chubb, CSE, Esurance, Farmers Insurance, Geico (or Berkshire Hathaway), Kemper Preferred, Metlife, Nat Gen Premier, National General, Nationwide, Allied, Progressive, Safeco, Stillwater, The Hartford, Travelers, USAA, Liberty Mutual, Zurich, CNA, Amtrust, Tokio Marine, Auto Owners Group, Erie, American Financial, W.R. Berkeley, Assurant, QBE, etc.

In any of the systems, methods, or readable storage media described herein, the present disclosure further comprises receiving 1 to 10 (e.g., 1, 2, 3, 4, 5, 6, 7, 8, 9, 10) pieces of information from the customer, wherein the information is selected from any of: phone number, driver's license info, name, date of birth (“DOB”), address, SSN, gender, email address. In some embodiments, the customer provides the following 1 piece of info: phone number. In some embodiments, the customer provides the following 2 pieces of info: Phone number and driver's license information (e.g., the driver's license information may be obtained from scanning the driver's license, or customer entering the information). In some embodiments, the customer provides the following 2 pieces of info: phone number and name. In some embodiments, the customer provides the following 2 pieces of info: Phone number and DOB. In some embodiments, the customer provides any combination of one or more pieces of the following information: phone number, address, SSN, name, DOB, gender, and driver's license info.

In some embodiments, the customer can supply any single piece of the following information: phone number, SSN, Driver's license information (state where the license is issued+license number), and email address.

In some embodiments, the customer provides any of the following two pieces of information: phone number+driver's license number (whether by scanning the driver's license, or typing in the driver's license number); phone number+name; phone number+DOB; phone number+address; phone number+SSN; SSN+name; driver's license information+name; phone number+email address; and email address+name.

In some embodiments, the customer provides any of the following 3 pieces of information: phone number+name+address; phone number+name+DOB; phone number+name+driver's license number; driver's license information+name+address; driver's license information+name+DOB; phone number+name+email address; and email+name+address.

In some embodiments, the customer provides any of the following 4 pieces of information: phone number+name+DOB+address; phone number+name+driver's license number+DOB;

In some embodiments, the customer provides any of the following 5 pieces of information: phone number+name+DOB+address+gender; phone number+name+driver's license number+address; phone number+name+driver's license number+address+DOB; and phone number+name+driver's license number+address+DOB+gender.

In any of the systems, methods, or readable storage media described herein, the disclosure comprises processing the responses from each of the multiple data or identity databases (or data or identity services) to determine the accuracy of the at least one of date of birth, address, or social security number of the customer in each response, generate a profile (such as verified profile) based on the determined accuracy that includes the customer's name, phone number, date of birth, address and social security number.

In any of the systems, methods, or readable storage media described herein, the disclosure comprises instructions being executable by one or more processors to perform a method for creating a profile of a customer for a financial service or financial product rating process (or a financial service or financial product), the method comprising the following steps: (a) receiving customer's phone number from the customer; (b) using the customer's phone number to query one or more data or identity databases (or data or identity services) to obtain additional information related to the customer, wherein the additional information is not provided by the customer; (c) transmitting the customer information obtained from the steps (a) and (b) to an financial service (or financial product) rating server (or pricing server) to compute a price or price estimate, whereby the financial service (or financial product) rating server (or pricing server) computes the price or price estimate based on the transmitted information. In some embodiments, the information from step (b) includes at least one of date of birth, address, or social security number of the customer. If more than one name or address is identified from the identity query, the present disclosure further includes receiving name information and/or address information from the customer.

In any of the systems, methods, or readable storage media described herein, the disclosure comprises sending additional query based on the information received from the customer and/or the information obtained from one or more identity query or queries based on the information received from the customer. In some embodiments, the additional query or queries includes one or more queries for customer's driver license number or information, the customer's car information (e.g., car year, make, model, sub-model, trim, etc.) or vehicle identification number (VIN), household member information or household member name (and/or address, date of birth, gender, etc.), customer's current insurance coverage limits, customer or household member's MVR (or traffic violation(s) or accident(s)) and/or CLUE report, customer or household member's insured property or properties (and/or type of ownership for insured property, whether leased or owned), customer or household member's credit score or history, customer or household's insurance score, primary use of the insured property, marital status, customer or household member's occupation (or profession), and/or customer or household member's education.

In any of the systems, methods, or readable storage media described herein, the financial service or financial product rating process (or a financial service or financial product) is for at least one of: insurance, loan, investment, refinance, fund transfer, rental, and lease. In some embodiments, the insurance is personal insurance, auto insurance, home insurance (or renters or condo insurance), liability insurance (e.g., personal liability insurance), umbrella insurance, life insurance, health insurance, or accident insurance. In some embodiments, the loan is home mortgage, auto mortgage, loan not based on auto or home, student loan, event-based loan such as wedding, home improvement or remodeling. In some embodiments, the auto insurance includes liability coverage(s), comprehensive, collision, or state required minimum coverages for liability.

In any of the systems, methods, or readable storage media described herein, the information received from the customer and the information obtained from querying one or more data or identity databases (or data or identity services) is all the information necessary or required to obtain a rate, price or price estimate in the financial service or financial product rating process (or a financial service or financial product). In some embodiments, the price, for example an exact price or an estimate is presented to the customer or customer's agent or representative. In some embodiments, the disclosure further comprises transmitting the price to the customer or customer's agent or representative. In some embodiments, the customer profile is used in an insurance service or product rating process, or for obtaining a rate, price or price estimate from an insurance company. In some embodiments, the financial service or product is an insurance product provided by an insurance company. Insurance company or carrier may be an auto insurance provider (or company or carrier) or a home insurance provider (or company or carrier).

In any of the systems, methods, or readable storage media described herein, the information received from the customer may be provided by customer directly, or by customer indirectly (e.g., through customer's family member, agent or representative, intermediary such as an insurance company).

In some embodiments, based on the information received from the customer, multiple queries of data or identity databases or services are performed, to obtain information necessary or required to provide a rate, price or price estimate for a customer. In some embodiments, the information necessary or required in a financial service or financial product rating process or for providing rate, price or price estimate for a financial service or financial product is provided by customer or customer's family member, agent or representative. In some embodiments, the information necessary or required in a financial service or financial product rating process or for providing rate, price or price estimate for a financial service or financial product is obtained from querying one or more data or identity databases (or data or identity services). Any of the information described herein may include any one or more of the following: customer's (or customer's family member or customer's household's) name, address, date of birth (“DOB”), phone number, social security number (SSN), gender, driver's license information, marital status, name of the current financial service or product provider, and/or email address. Any of the information described herein may further include any one or more of the following driver or car attributes (e.g., for driver/car insured or car financed or refinanced): car make/model/year, VIN, car ownership type, years of driving experience, anti-theft, theft recovery system, passive restraints, anti-lock brakes, daytime running lights, cost of new car, vehicle use, annual driving miles, miles one way (if commute to work/school), number of days per week for commute, car garaging address, odometer reading, motor vehicle report, accidents and traffic violations.

Any of the information described herein may further include any one or more of the following property attributes: address of property insured (or financed, or refinanced), all the attributes of the property, years at the address, year built, purchase date, purchase price, bought from short sale or the property is currently in foreclosure, construction style, square footage, foundation type, number of stories, information relating to: roof type/material, roof design, exterior walls, garage type and size, number of full bathrooms, number of half bathrooms, fireplace number and type, wall material, finishes, flooring materials, detached structures, deck (square footage or size), interior finishes, Spa or hot tub, dwelling type, dwelling occupancy/usage, number of apartments, protection class, inside city limits, feet from hydrant, distance from fire station, within fire district, number of residents in household, heating type, secondary heating source, central air conditioning, number of house fan in attic, ceiling material.

Any of the information described herein may further include any one or more of the following: customer or customer family member's credit score, such as FICO score, or other score indicating customer's credit worthiness, customer insurance score, customer or customer family member or household's following information: income, education, occupation, student or not, existing mortgage or debt information, amount, interest, collateral, and payment information and status, claim loss history from current or past insurance policies, current insurance coverage limits (such as bodily injury limits, property damage limits, medical payments, uninsured or underinsured motorist limits, comprehensive deductible, collision deductible, towing/roadside service, rental/transportation expense, full glass replacement, parked car collision coverage), expiration date, premium, carrier name, years with current carrier, years with continuous coverage.

In any of the systems, methods or readable storage media described herein, the present disclosure further comprises storing the profile as a record in a database. In some embodiments, the profile is a verified profile or basic profile. Based on the customer profile, additional queries to data service(s) or database(s) may be performed to obtain additional information necessary or required for providing rate, price or price estimate for a financial service or product.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for creating a profile of a customer for a financial service rating process, the system comprising:
one or more hardware processors configured by machine-readable instructions to:
receive a phone number from the customer;
send a message to the device associated with the phone number requesting a specific response;
receive the specific response from the customer to verify that the customer has possession of the device associated with the phone number;
send an identity query to each of multiple identity services, the identity query including the customer's name and phone number;
in response to the identity query, receive a response from each of the multiple identity services, each response including at least one of date of birth, address, or social security number of the customer;
process the responses from each of the multiple identity services to determine the accuracy of the at least one of date of birth, address, or social security number of the customer in each response, generate a verified basic profile of the user based on the determined accuracy; and
store the basic profile as a record in a database.

2. The system of claim 1, wherein the one or more hardware processors are further configured by machine-readable instructions to:
send a social query to each of multiple online social profiles of the customer, the social query including information in the basic profile; and
in response to the social query, receive additional information related to the customer, the additional information including at least one of email address, education level, or profession; and
store the additional information in the database in correspondence to the basic profile.

3. The system of claim 2:
wherein the one or more hardware processors are further configured by machine-readable instructions to send a credit query to a credit scoring database, the credit query including at least the social security number of the customer;
wherein the one or more hardware processors are further configured by machine-readable instructions to in response to the credit query, receive credit history information of the customer;
wherein the one or more hardware processors are further configured by machine-readable instructions to store the credit history information in the database in correspondence to the basic profile.

4. The system of claim 3, wherein the one or more hardware processors are further configured by machine-readable instructions to:
send an insurance query to each of multiple insurance provider databases, the insurance query including information from the basic profile, the additional information or the credit information;
in response to the insurance query, receive insurance information relating to the customer's insured asset;
store the insurance information in the database in correspondence to the basic profile.

5. The system of claim 4, wherein the insurance information relating to the customer's insured asset includes at least one of an identification of the asset, the parties insured, and policy coverage details.

6. The system of claim 4, wherein the insurance information relating to the customer's insured asset includes at least one year, make, model, trim, and vin of an automobile, and driver's details corresponding the customer.

7. The system of claim 1, wherein requesting the customer's name comprises sending a name query to a caller id service, the name query including the phone number,
wherein the one or more hardware processors are further configured by machine-readable instructions to receive the customer name comprises receiving a response to name query.

8. The system of claim 1, wherein the message is an SMS message and the specific response includes a code in the SMS message.

9. The system of claim 1, wherein the processing includes disambiguation of data in the responses from each of the multiple identity services by comparing corresponding data in the responses from each of the multiple identity services and determining the reliability of the data based on the comparison.

10. The system of claim 1, wherein the device associated with the phone number is a mobile phone.

11. The system of claim 1, wherein the financial service is auto insurance.

12. The system of claim 4, wherein the one or more hardware processors are further configured by machine-readable instructions to determine a premium for automobile insurance based on the basic profile, the additional information, the credit history information, and the insurance information.

13. The system of claim 1, wherein the basic profile includes the customer's name, phone number, date of birth, address and social security number.

14. A method for creating a profile of a customer for a financial service rating process, the method comprising:
receiving a phone number from the customer;
sending a message to the device associated with the phone number requesting a specific response;
receiving the specific response from the customer to verify that the customer has possession of the device associated with the phone number;
requesting the customer's name;
receiving the customer's name;
sending an identity query to each of multiple identity services, the identity query including the customer's name and phone number;
in response to the identity query, receiving a response from each of the multiple identity services, each response including at least one of date of birth, address, or social security number of the customer;
processing the responses from each of the multiple identity services to determine the accuracy of the at least one of date of birth, address, or social security number of the customer in each response;
generate a verified basic profile base on the determined accuracy; and
storing the basic profile as a record in a database.

15. The method of claim 14, further comprising:
sending a social query to each of multiple online social profiles of the customer, the social query including information in the basic profile; and
in response to the social query, receiving additional information related to the customer, the additional information including at least one of email address, education level, or profession; and
storing the additional information in the database in correspondence to the basic profile.

16. The method of claim 15:
sending a credit query to a credit scoring database, the credit query including at least the social security number of the customer;
in response to the credit query, receiving credit history information of the customer; and
storing the credit history information in the database in correspondence to the basic profile.

17. The method of claim 16, further comprising:
sending an insurance query to each of multiple insurance provider databases, the insurance query including information from the basic profile, the additional information or the credit information;
in response to the insurance query, receiving insurance information relating to the customer's insured asset; and
storing the insurance information in the database in correspondence to the basic profile.

18. The method of claim 17, wherein the insurance information relating to the customer's insured asset includes at least one of an identification of the asset, the parties insured, and policy coverage details.

19. The method of claim 17, wherein the insurance information relating to the customer's insured asset includes at least one year, make, model, trim, and vin of an automobile, and driver's details corresponding the customer.

20. The method of claim 14, wherein requesting the customer's name is comprises sending a name query to a caller id service, the name query including the phone number, and receiving the customer name comprises receiving a response to name query.

21. The method of claim 14, wherein the message is an SMS message and the specific response includes a code in the SMS message.

22. The method of claim 14, wherein the processing includes disambiguation of data in the responses from each of the multiple identity services by comparing corresponding data in the responses from each of the multiple identity services and determining the reliability of the data based on the comparison.

23-40. (canceled)
